(19) United States
(12) Patent Application Publication
(10) Pub. No.: US 2025/0182473 A1
(43) Pub. Date: Jun. 5, 2025

(54) DRONE-BASED MOBILE PRECISION SURVEYING METHOD FOR TERRESTRIAL TERRAIN, DEVICE, MEDIUM, AND PRODUCT

(71) Applicant: China Three Gorges University, Yichang (CN)

(72) Inventors: Changwen LI, Yichang (CN); Rui ZHOU, Yichang (CN); Sujing LIN, Yichang (CN); Liting YANG, Yichang (CN); Jiale HUANG, Yichang (CN); Jiaqi ZHU, Yichang (CN); Zhiwei LI, Yichang (CN); Feihan LI, Yichang (CN); Jiarui LI, Yichang (CN); Xiaoxia ZENG, Yichang (CN); Haoxiong ZHAN, Yichang (CN)

(21) Appl. No.: 19/050,009

(22) Filed: Feb. 10, 2025

(30) Foreign Application Priority Data
Apr. 10, 2024 (CN) 202410431333.3

(51) Int. Cl. G06V 20/17; G01S 19/48; G06T 7/73; G06T 17/05; H04W 4/029

(52) U.S. Cl. CPC G06V 20/17; G01S 19/485; G06T 7/73; G06T 17/05; H04W 4/029; G06T 2207/10032

(57) ABSTRACT

A drone-based mobile precision surveying method for terrestrial terrain, a device, a medium, and a product are provided. The method includes: determining regional terrain data of a target area based on three-dimensional coordinate data of image control points in the target area and position information of a drone by using a real-time dynamic differential positioning technology; correcting regional terrain data of a signal-deficient area in the target area based on the three-dimensional coordinate data of the image control points and the regional terrain data by using the real-time dynamic differential positioning technology, to obtain corrected regional terrain data of the signal-deficient area; and integrating regional terrain data of a signal-covered area in the target area and the corrected regional terrain data of the signal-deficient area by using a Geographic Information System (GIS) integration method to obtain corrected regional terrain data of the target area.

### CROSS REFERENCE TO RELATED APPLICATION

This patent application claims the benefit and priority of Chinese Patent Application No. 202410431333.3, filed with the China National Intellectual Property Administration on Apr. 10, 2024, the disclosure of which is incorporated by reference herein in its entirety as part of the present application.

### TECHNICAL FIELD

The present disclosure relates to the technical field of terrain surveying, and in particular, to a drone-based mobile precision surveying method for terrestrial terrain that utilizes image control points, real-time kinematic positioning (RTK), and radio, a device, a medium, and a product.

### BACKGROUND

Surveying is fundamental to the planning and design of hydraulic engineering projects. Hydraulic engineering projects are often constructed in areas with high flow rates and large water storage capacities, such as rivers and lakes. It is essential to scientifically plan the engineering content based on local hydrological conditions. Therefore, obtaining accurate terrain data plays a crucial role in the preparatory work for engineering construction. Inaccurate terrain data can severely affect the quality of hydraulic projects, causing designed reservoir capacity and water levels to be discrepant from actual project conditions, as well as posing safety risks.

To achieve precise terrain surveying, drones are commonly used in conjunction with RTK technology to obtain three-dimensional coordinate data of areas to be surveyed. In areas with signal coverage, drones can conduct aerial surveys above the ground, obtaining both absolute and relative positions of the terrestrial terrain. All data is then systematically integrated to produce comprehensive terrain data information. In remote areas of China, such as Xinjiang and Tibet, where the terrain and hydrological conditions are complex and hydrological research is limited, there is an urgent need for terrain surveying to obtain accurate terrain data, providing essential foundational data for engineering construction. However, due to the remoteness and poor signal conditions in these areas, conventional methods cannot achieve the goal of precise surveying. In signal-deficient areas, drones cannot accurately follow the intended flight path, leading to deviations in the navigation of drones and the inability to obtain accurate position data. Additionally, due to the complex terrain in these signal-deficient areas, there are significant deviations in the final terrain data obtained, severely impacting the quality of subsequent engineering work.

### SUMMARY

An objective of the present disclosure is to provide a drone-based mobile precision surveying method for terrestrial terrain, a device, a medium, and a product, which can support the acquisition and processing of terrain surveying data in signal-deficient areas with complex terrain, filling the gaps in terrain data and strengthening the weakness in measurement technology for such complex areas.

To achieve the above objective, the present disclosure provides the following technical solutions.

According to a first aspect, the present disclosure provides a drone-based mobile precision surveying method for terrestrial terrain, which includes:
acquiring three-dimensional coordinate data of image control points in a target area and position information of a drone, where the target area includes a signal-covered area and a signal-deficient area;
determining regional terrain data of the target area based on the three-dimensional coordinate data of the image control points in the target area and the position information of the drone by using a real-time dynamic differential positioning technology, where the regional terrain data includes regional terrain data of the signal-covered area and regional terrain data of the signal-deficient area;
correcting the regional terrain data of the signal-deficient area based on the three-dimensional coordinate data of the image control points in the target area and the regional terrain data of the target area by using the real-time dynamic differential positioning technology, to obtain corrected regional terrain data of the signal-deficient area; and
integrating the regional terrain data of the signal-covered area and the corrected regional terrain data of the signal-deficient area by using a Geographic Information System (GIS) integration method to obtain corrected regional terrain data of the target area.

Optionally, before said acquiring the three-dimensional coordinate data of the image control points in the target area and the position information of the drone, where the target area includes the signal-covered area and the signal-deficient area, the method further includes:
deploying the image control points in the target area by using a uniform layout method;
measuring initial three-dimensional coordinates of each image control point using measuring instruments; and
correcting the initial three-dimensional coordinates of each image control point based on a Global Positioning System real-time kinematic positioning (GPS RTK) multi-point correction method to obtain the three-dimensional coordinate data of the image control points in the target area.

Optionally, said determining the regional terrain data of the target area based on the three-dimensional coordinate data of the image control points in the target area and the position information of the drone by using the real-time dynamic differential positioning technology specifically includes:
dividing the target area into multiple grids based on the three-dimensional coordinate data of the image control points in the target area; and
determining the regional terrain data of the target area based on absolute positions of the drone at different times, relative positions of each grid to each image control point, and relative positions of the drone to each grid during aerial survey of the drone at different times by using the real-time dynamic differential positioning technology, where the absolute positions of the drone at different times, the relative positions of each grid to each image control point, and the relative positions of the drone to each grid during the aerial survey of the drone are obtained through data signal transmission via radio.

Optionally, said correcting the regional terrain data of the signal-deficient area based on the three-dimensional coordinate data of the image control points in the target area and the regional terrain data of the target area by using the real-time dynamic differential positioning technology, to obtain the corrected regional terrain data of the signal-deficient area specifically includes:
determining relative positions of each grid in the signal-deficient area to image control points in the signal-covered area based on the three-dimensional coordinate data of the image control points in the target area, where the grids are obtained by dividing the target area;
obtaining absolute positions of the drone at different times in the signal-deficient area through coordinate transformation based on the relative positions of each grid in the signal-deficient area to the image control points in the signal-covered area; and
obtaining the corrected regional terrain data of the signal-deficient area based on the absolute positions of the drone at different times in the signal-deficient area, relative positions of each grid to each image control point, and relative positions of the drone to each grid by using a real-time differential positioning technology, where the relative positions of each grid to each image control point and the relative positions of the drone to each grid are obtained through data signal transmission via radio.

Optionally, said obtaining the absolute positions of the drone at different times in the signal-deficient area through coordinate transformation based on the relative positions of the grids in the signal-deficient area to the image control points in the signal-covered area specifically includes:
determining the absolute positions of the drone at different times in the signal-deficient area according to the following formula: Bₒₚₚ₃=Bₒₚₚ₁+Bₙₒ−B_{signal};
where Bₒₚₚ₃ is the absolute positions of the drone in the signal-deficient area at different times, Bₒₚₚ₁ is the relative positions of each grid to each image control point, Bₙₒ is three-dimensional coordinates of image control points in the signal-deficient area, and B_{signal} is the three-dimensional coordinates of the image control points in the signal-covered area.

Optionally, said obtaining the absolute positions of the drone at different times in the signal-deficient area through coordinate transformation based on the relative positions of the grids in the signal-deficient area to the image control points in the signal-covered area specifically includes:
obtaining the absolute positions of the drone at different times in the signal-deficient area according to the following formula: B_{abs}′=Bₒₚₚ₂+Bₒₚₚ₃;
where B_{abs}′ is the absolute positions of the drone in the signal-deficient area at different times, Bₒₚₚ₂ is the relative positions of the drone to each grid, and Bₒₚₚ₃ is the relative positions of the grids in the signal-deficient area to the image control points in the signal-covered area.

Optionally, said obtaining the corrected regional terrain data of the signal-deficient area based on the absolute positions of the drone at different times in the signal-deficient area, the relative positions of each grid to each image control point, and the relative positions of the drone to each grid by using the real-time differential positioning technology specifically includes:
obtaining the corrected regional terrain data of the signal-deficient area according to the following formula: B_{bef2}′=DIFF(B_{abs}′, Bₒₚₚ₁, Bₒₚₚ₂).
where B_{bef2}′ is the corrected regional terrain data of the signal-deficient area; B_{abs}′ is the absolute positions of the drone in the signal-deficient area at different times, Bₒₚₚ₁ is the relative positions of each grid to each image control point, Bₒₚₚ₂ is the relative positions of the drone to each grid, and DIFF( ) is a real-time differential function.

According to a second aspect, the present disclosure provides a computer device, including a memory, a processor, and a computer program stored in the memory and executable on the processor, where the processor executes the computer program to implement the steps of the drone-based mobile precision surveying method for terrestrial terrain as described in the first aspect.

According to a third aspect, the present disclosure provides a computer-readable storage medium that stores a computer program, where the computer program is executed by a processor to implement the steps of the drone-based mobile precision surveying method for terrestrial terrain as described in the first aspect.

According to a fourth aspect, the present disclosure provides a computer program product, including a computer program, where the computer program or an instruction is executed by a processor to implement the steps of the drone-based mobile precision surveying method for terrestrial terrain as described in the first aspect.

According to specific embodiments of the present disclosure, the present disclosure has the following technical effects:

The present disclosure provides a drone-based mobile precision surveying method for terrestrial terrain, a device, a medium, and a product. The method includes: acquiring three-dimensional coordinate data of image control points in a target area and position information of a drone, where the target area includes a signal-covered area and a signal-deficient area; determining regional terrain data of the target area based on the three-dimensional coordinate data of the image control points in the target area and the position information of the drone by using a real-time dynamic differential positioning technology, where the regional terrain data includes regional terrain data of the signal-covered area and regional terrain data of the signal-deficient area; correcting the regional terrain data of the signal-deficient area based on the three-dimensional coordinate data of the image control points in the target area and the regional terrain data of the target area by using the real-time dynamic differential positioning technology, to obtain corrected regional terrain data of the signal-deficient area; and integrating the regional terrain data of the signal-covered area and the corrected regional terrain data of the signal-deficient area by using a GIS integration method to obtain corrected regional terrain data of the target area. The present disclosure combines terrain data of image control points in the signal-covered area with terrain data of image control points in the signal-deficient area, and separates and corrects inaccurate terrain data in the signal-deficient area by using an RTK real-time differential technology, thereby solving the problem of inaccurate terrain surveying in areas with poor signal conditions.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can still be derived from these accompanying drawings by those of ordinary skill in the art without creative efforts.

FIG. 1 is a schematic flowchart of a drone-based mobile precision surveying method for terrestrial terrain according to Embodiment 1 of the present disclosure;

FIG. 2A is the technical roadmap of the present disclosure (data measurement part), and FIG. 2B is the technical roadmap of the present disclosure (data processing part);

FIG. 3 is a schematic diagram of surveying according to Embodiment 1 of the present disclosure; and

FIG. 4 is a diagram of an internal structure of a computer device according to Embodiment 2 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a drone-based mobile precision surveying method for terrestrial terrain, a device, a medium, and a product, which can support the acquisition and processing of terrain surveying data in signal-deficient areas with complex terrain, filling the gaps in terrain data and strengthening the weakness in measurement technology for such complex areas.

In order to make the above objective, features and advantages of the present disclosure clearer and more comprehensible, the present disclosure will be further described in detail below in combination with accompanying drawings and particular implementation modes.

### Embodiment 1

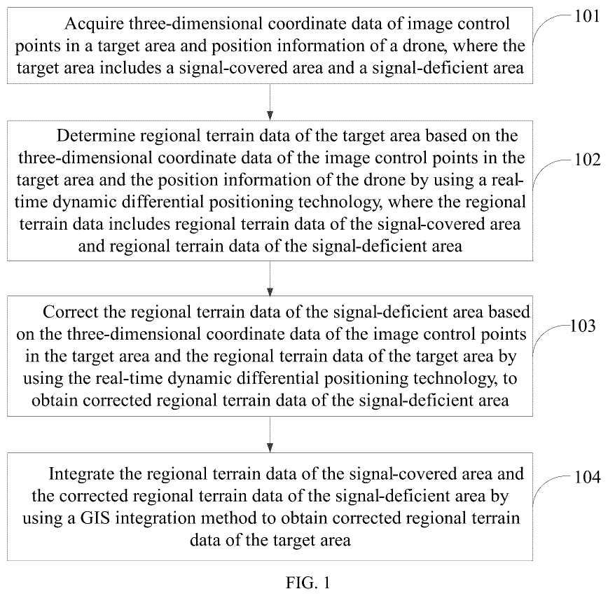

As shown in FIG. 1, this embodiment provides a drone-based mobile precision surveying method for terrestrial terrain, which includes the following steps:

Step 101: Acquire three-dimensional coordinate data of image control points in a target area and position information of a drone, where the target area includes a signal-covered area and a signal-deficient area.

Step 102: Determine regional terrain data of the target area based on the three-dimensional coordinate data of the image control points in the target area and the position information of the drone by using a real-time dynamic differential positioning technology, where the regional terrain data includes regional terrain data of the signal-covered area and regional terrain data of the signal-deficient area.

Step 103: Correct the regional terrain data of the signal-deficient area based on the three-dimensional coordinate data of the image control points in the target area and the regional terrain data of the target area by using the real-time dynamic differential positioning technology, to obtain corrected regional terrain data of the signal-deficient area.

Step 104: Integrate the regional terrain data of the signal-covered area and the corrected regional terrain data of the signal-deficient area by using a GIS integration method to obtain corrected regional terrain data of the target area.

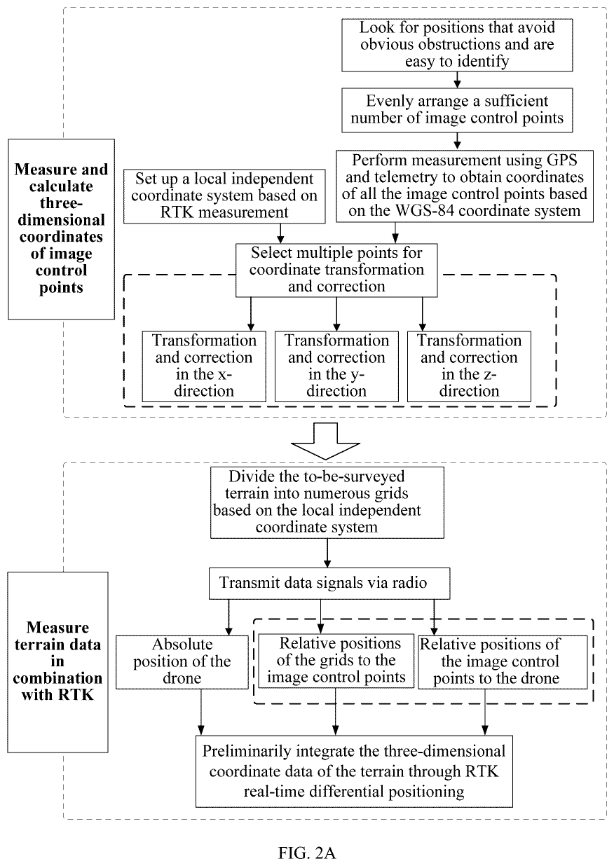

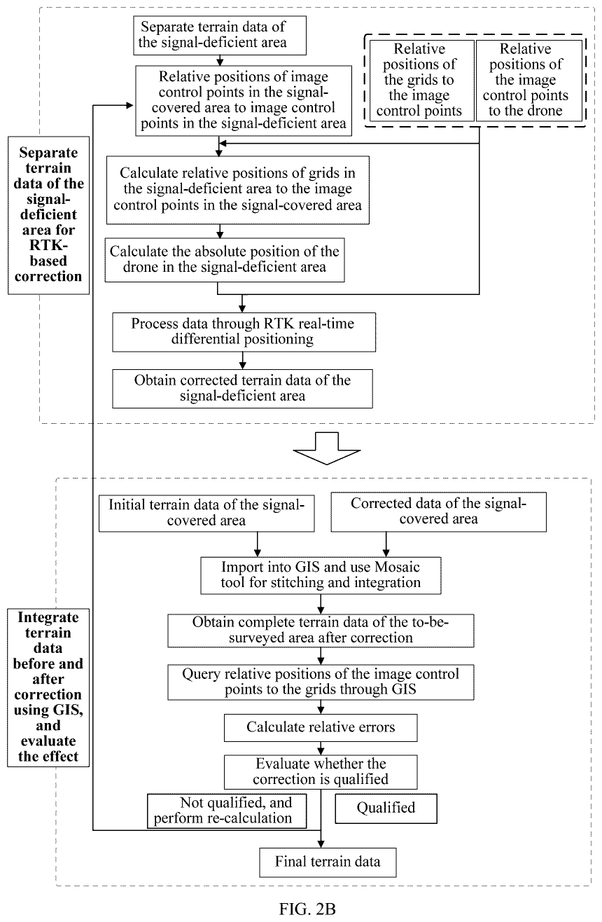

Before step 101, as shown in FIGS. 2A-2B, the method may further include:

deploying the image control points in the target area by using a uniform layout method;

measuring initial three-dimensional coordinates of each image control point using measuring instruments; and

correcting the initial three-dimensional coordinates of each image control point based on a GPS RTK multi-point correction method to obtain the three-dimensional coordinate data of the image control points in the target area.

Specifically, the three-dimensional coordinates of the image control points can be measured and calculated as follows:

1) Multiple image control points X(n) are relatively evenly distributed at positions that avoid obvious obstructions and are easy to identify in the to-be-surveyed area, where n=1, 2, 3, . . . , m, so that the image control points can cover the entire to-be-surveyed area.

2) Three-dimensional coordinates of all the image control points XK(n) based on the WGS-84 coordinate system are obtained by using measuring instruments such as GPS and telemetry:

A(n)=(ax,ay,az),n=1,2,3, . . . ,m.

3) Local independent coordinate system based on RTK measurement is set for the image control points XK(n) as follows:

B(n)=(bx,by,bz),n=1,2,3, . . . ,m.

4) Coordinate system transformation and correction are performed using the GPS RTK multi-point correction method, selecting at least three points for calculation, with calculation formulas for x, y, z directions as follows:

ax(n)=bx(n)×transx(n),n=1,2,3, . . . ,m;

$$\begin{matrix}averx = \frac{{\sum }_{1}^{k} transx ( n )}{m} , n = 1 , 2 , 3 , … , m ; \\ bx ( n ) = ax ( n ) + averx , n = 1 , 2 , 3 , … , m ;\end{matrix}$$

where ax(n) is an x-coordinate of the n-th image control point based on the WGS-84 coordinate system, bx(n) is an x-coordinate of the n-th image control point based on RTK measurement in the local independent coordinate system, transx(n) is a difference in the x-direction between the WGS-84 coordinate system and the local independent coordinate system for the n-th image control point, and averx is a conversion difference in the x-direction between the two coordinate systems for all the selected points.

$$\begin{matrix}ay ( n ) = by ( n ) - transy ( n ) , n = 1 , 2 , 3 , … , m ; \\ avery = \frac{{\sum }_{1}^{k} transy ( n )}{m} , n = 1 , 2 , 3 , … , m ; \\ by ( n ) = ay ( n ) + avery , n = 1 , 2 , 3 , … , m ;\end{matrix}$$

where ay(n) is a y-coordinate of the n-th image control point based on the WGS-84 coordinate system, by(n) is a y-coordinate of the n-th image control point based on RTK measurement in the local independent coordinate system, transy(n) is a difference in the y-direction between the WGS-84 coordinate system and the local independent coordinate system for the n-th image control point, and avery is a conversion difference in the y-direction between the two coordinate systems for all the selected points.

$$\begin{matrix}az ( n ) = bz ( n ) - transz ( n ) , n = 1 , 2 , 3 , … , m ; \\ averz = \frac{{\sum }_{1}^{k} transz ( n )}{m} , n = 1 , 2 , 3 , … , m ; \\ bz ( n ) = az ( n ) + averz , n = 1 , 2 , 3 , … , m ;\end{matrix}$$

where az(n) is a z-coordinate of the n-th image control point based on the WGS-84 coordinate system, bz(n) is a z-coordinate of the n-th image control point based on RTK measurement in the local independent coordinate system, transz(n) is a difference in the z-direction between the WGS-84 coordinate system and the local independent coordinate system for the n-th image control point, and averz is a conversion difference in the z-direction between the two coordinate systems for all the selected points.

Finally, the three-dimensional coordinates of each image control point based in the local independent coordinate system based on RTK measurement can be obtained using the following formula:

$$B ( n ) = A ( n ) + ( averx , avery , averz ) .$$

As shown in FIGS. 2A-2B, during execution, step 102 may specifically include the following steps:

Step 201: Divide the target area into multiple grids based on the three-dimensional coordinate data of the image control points in the target area.

Step 202: Determine the regional terrain data of the target area based on absolute positions of the drone at different times, relative positions of each grid to each image control point, and relative positions of the drone to each grid during aerial survey of the drone at different times by using the real-time dynamic differential positioning technology, where the absolute positions of the drone at different times, the relative positions of each grid to each image control point, and the relative positions of the drone to each grid during the aerial survey of the drone are obtained through data signal transmission via radio.

Specifically, the terrain to be surveyed (the target area) is divided into numerous grids, with three-dimensional coordinates of each grid in the local independent coordinate system based on RTK measurement being defined as:

B(i),i=1,2,3, . . . ,j;

where i is an index of the grid, j is the total number of grids, and B(i) is three-dimensional coordinates of the i-th grid in the local independent coordinate system based on RTK measurement.

Through data signal transmission via radio, the absolute positions B_{abs} of the drone at different times during the aerial survey (i.e., the three-dimensional coordinates in the local independent coordinate system based on RTK measurement), the relative positions Bₒₚₚ₁ of each grid B(i) to each image control point XK(n), and the relative positions Bₒₚₚ₂ of the drone to each B(i) at different times during the aerial survey can be obtained.

Using the RTK real-time differential positioning technology, the three types of data acquired can be preliminarily integrated to obtain the three-dimensional coordinates B_{bef} of each grid in the to-be-surveyed area based on the local independent coordinate system, with the calculation formula as follows:

B_{bef}=DIFF(B_{abs},Bₒₚₚ₁,Bₒₚₚ₂).

where B_{abs} is the absolute position of the drone, Bₒₚₚ₁ is the relative position of each image control point to each grid, Bₒₚₚ₂ is the relative position of the drone to each grid, DIFF( ) is a real-time differential function, and DIFF(B_{abs}, Bₒₚₚ₁, Bₒₚₚ₂) indicates that the input of the three different types of data results in terrain data with higher precision.

As shown in FIGS. 2A-2B, during execution, step 103 may specifically include the following steps:

Step 301: Determine relative positions of each grid in the signal-deficient area to image control points in the signal-covered area based on the three-dimensional coordinate data of the image control points in the target area, where the grids are obtained by dividing the target area.

Step 302: Obtain absolute positions of the drone at different times in the signal-deficient area through coordinate transformation based on the relative positions of each grid in the signal-deficient area to the image control points in the signal-covered area.

Step 303: Obtain the corrected regional terrain data of the signal-deficient area based on the absolute positions of the drone at different times in the signal-deficient area, relative positions of each grid to each image control point, and relative positions of the drone to each grid by using a real-time differential positioning technology, where the relative positions of each grid to each image control point and the relative positions of the drone to each grid are obtained through data signal transmission via radio.

During execution of step 301, the specific operation process is as follows:

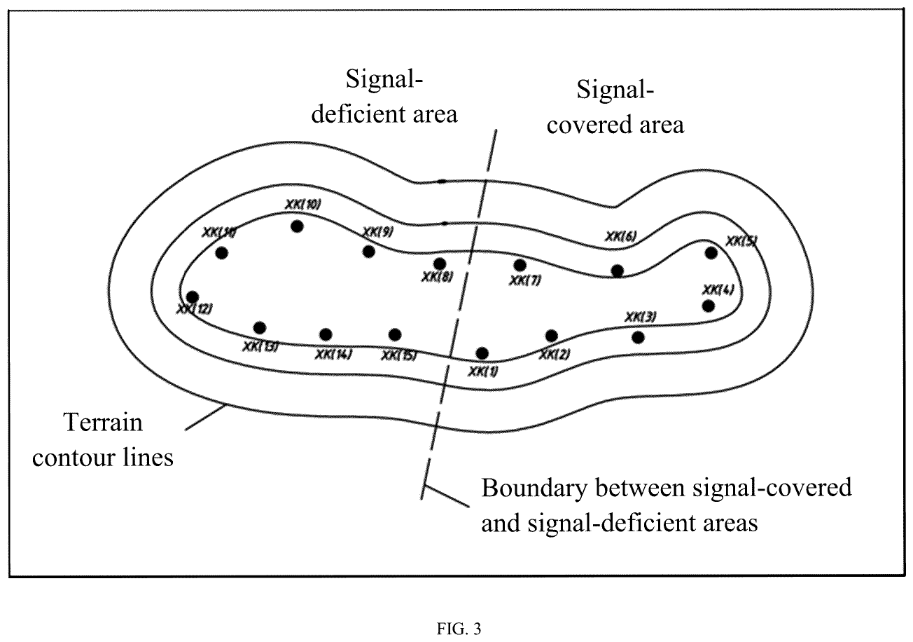

First, the drone needs to perform flight tasks within the to-be-surveyed area to measure and collect terrain data. The data will subsequently be subdivided into terrain data from the signal-covered area and terrain data from the signal-deficient area based on the completeness of the information received by the drone, as shown in FIG. 3.

For the data from the signal-deficient area, due to incomplete information reception by the drone, the flight trajectory may deviate from the predetermined route. Therefore, the absolute position data of the drone will have errors and cannot be directly used for subsequent calculation and analysis.

However, even in the signal-deficient area, some key data can still be acquired, such as relative positional relationships between each grid and each image control point, as well as relative positional information of the drone to each grid at different time points during the aerial survey. Such data will be used in subsequent data processing and analysis.

During execution, steps 302-303 can be specifically implemented as follows:

1) The three-dimensional coordinates B_{bef} of each grid in the to-be-surveyed area based on the local independent coordinate system are divided into the three-dimensional coordinates B_{bef1} of grids in the signal-covered area and the three-dimensional coordinates B_{bef2} of grids in the signal-deficient area based on whether there is a signal, where data of B_{bef1} is retained, while B_{bef2} needs correction.

2) Based on the three-dimensional coordinates B_{signal} of the image control points XK_{signal} in the signal-covered area and the three-dimensional coordinates Bₙₒ of the image control points XKₙₒ in the signal-deficient area, the relative positions Bₒₚₚ₃ of each grid B(i) in the signal-deficient area to the image control points XK_{signal} in the signal-covered area, with the calculation formula as follows:

$${B}_{opp 3} = {B}_{opp 1} + {B}_{no} - {B}_{signal} .$$

3) Based on the relative positions Bₒₚₚ₃ of each grid B(i) in the signal-deficient area to the image control points XK_{signal} in the signal-covered area, the absolute position B_{abs}′ of the drone at different times in the signal-deficient area can be obtained through coordinate transformation, completing the correction of missing three-dimensional coordinate data due to the lack of signal, with the calculation formula as follows:

$${B}_{abs}^{′} = {B}_{opp 2} + {B}_{opp 3} .$$

4) Using the RTK real-time differential positioning technology, the three-dimensional coordinates B_{bef2}′ of each grid in the signal-deficient area based on the local independent coordinate system can be integrated from the three types of data obtained in 2), with the calculation formula as follows:

B_{bef2}′=DIFF(B_{abs}′,Bₒₚₚ₁,Bₒₚₚ₂);

where B_{abs}′ is the absolute positions of the drone at different times in the signal-deficient area, Bₒₚₚ₁ is the relative position of each grid to each image control point, Bₒₚₚ₂ is the relative position of the drone to each grid, DIFF( ) is a real-time differential function, and DIFF(B_{abs}, Bₒₚₚ₁, Bₒₚₚ₂) indicates that the input of the three different types of data results in the corrected terrain data for the signal-deficient area.

During execution of step 104, the calculation method may be specifically as follows:

First, the terrain data before and after correction are integrated based on GIS. The terrain data for the entire to-be-surveyed area consists of terrain data from the signal-covered area and terrain data from the signal-deficient area. The terrain data before correction is denoted as B_{bef}, with the calculation formula as follows:

$${B}_{bef} = {B}_{bef 1} + {B}_{bef 2} .$$

The terrain data after correction is denoted as Bar, with the calculation formula as follows:

$${B}_{af} = {B}_{bef 1} + {B}_{bef 2}^{′} ;$$

where B_{bef1} is the three-dimensional coordinates of each grid in the signal-covered area, B_{bef2} is the three-dimensional coordinates of each grid in the signal-deficient area before correction, and B_{bef2}′ is the three-dimensional coordinates of each grid in the signal-deficient area after correction.

Next, the three-dimensional coordinates B_{bef1} of each grid in the signal-covered area and the three-dimensional coordinates B_{bef2}′ of each grid in the signal-deficient area based on the local independent coordinate system are converted into ASCII format files and imported into GIS.

Using the Mosaic tool in GIS, relevant parameters are configured, to stitch together B_{bef1} and B_{bef2}′ into the same grid file, resulting in the corrected complete terrain data denoted as B_{af}:

After the corrected terrain data is obtained, the correction effect for the terrain data can be evaluated.

1) The relative positions B_{opp1gis} of each image control point XK(n) to each grid is queried using GIS, and a relative error E(n, i) is calculated for each point, with the calculation formula as follows:

$$E ( n , i ) = \frac{ABS ( {B}_{opp 1 gis} - {B}_{opp 1} )}{{B}_{opp 1}} \times 100 \% ;$$

where Bₒₚₚ₁ is the relative positions of each grid to each image control point, E(n, i) represents a relative error between the n-th image control point and the i-th grid, ABS( ) is an absolute value function, and ABS(B_{opp1gis}−Bₒₚₚ₁) represents absolute values of differences between the relative positions of each image control point to each grid and the relative positions of each grid to each image control point.

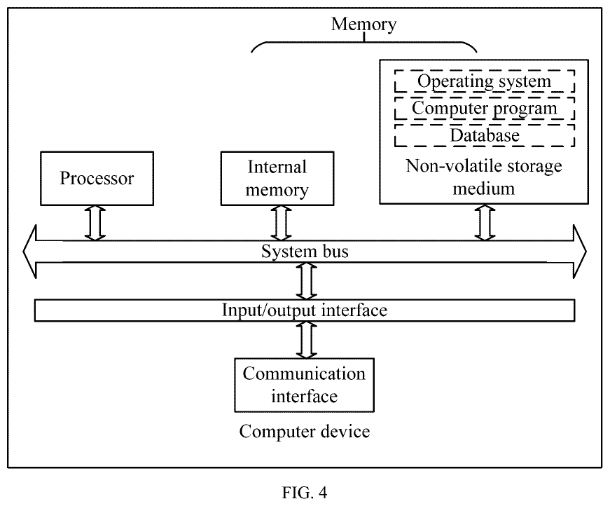

2) The smaller the relative error E(n, i) for each point, the closer the terrain data is to the true value, indicating a better correction effect of the terrain data; when the relative error E(n, i) for each point is less than 3%, it indicates that the surveying work is qualified; otherwise, re-measurement, correction, and calculation are required. In an embodiment, a computer device is provided. The computer device may be a database, and an internal structure thereof may be as shown in FIG. 4. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The database of the computer device is configured to store pending transactions. The I/O interface of the computer device is configured to exchange information between the processor and an external device. The communication interface of the computer device is configured to communicate with an external terminal through a network. When the computer program is executed by the processor, a data processing method is implemented.

In an embodiment, a computer device is provided, including a memory, a processor, and a computer program stored in the memory and executable on the processor. The processor executes the computer program to implement the steps of the above method embodiments.

In an embodiment, a computer-readable storage medium is provided. The computer-readable storage medium stores a computer program, and the computer program is executed by a processor to implement the steps of the above method embodiments.

In an embodiment, a computer program product is provided. The computer program product includes a computer program, and the computer program is executed by a processor to implement the steps of the above method embodiments.

It is to be noted that information of an object (including but not limited to device information of the object, personal information of the object and the like) and data (including but not limited to data for analysis, data for storage, data for exhibition and the like) in the present disclosure are information and data authorized by the object or fully authorized by each party, and relevant data shall be acquired, used and processed according to laws, regulations and standards of related countries and regions.

Those of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the foregoing method may be performed. Any reference to a memory, a storage, a database, or other media used in the embodiments of the present disclosure may include a non-volatile and/or volatile memory. The non-volatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM). The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Specific examples are used herein to explain the principles and implementations of the present disclosure. The description of the examples is merely intended to help understand the method of the present disclosure and its core ideas. In addition, those of ordinary skill in the art can make various modifications to the specific implementations and application scope in accordance with the teachings of the present disclosure. In conclusion, the content of the description shall not be construed as limitations to the present disclosure.

What is claimed is:

1. A drone-based mobile precision surveying method for terrestrial terrain, comprising:
acquiring three-dimensional coordinate data of image control points in a target area and position information of a drone, wherein the target area comprises a signal-covered area and a signal-deficient area;
determining regional terrain data of the target area based on the three-dimensional coordinate data of the image control points in the target area and the position information of the drone by using a real-time dynamic differential positioning technology, wherein the regional terrain data comprises regional terrain data of the signal-covered area and regional terrain data of the signal-deficient area;
correcting the regional terrain data of the signal-deficient area based on the three-dimensional coordinate data of the image control points in the target area and the regional terrain data of the target area by using the real-time dynamic differential positioning technology, to obtain corrected regional terrain data of the signal-deficient area; and
integrating the regional terrain data of the signal-covered area and the corrected regional terrain data of the signal-deficient area by using a Geographic Information System (GIS) integration method to obtain corrected regional terrain data of the target area.

2. The drone-based mobile precision surveying method for terrestrial terrain according to claim 1, wherein before said acquiring the three-dimensional coordinate data of the image control points in the target area and the position information of the drone, wherein the target area comprises the signal-covered area and the signal-deficient area, the method further comprises:
deploying the image control points in the target area by using a uniform layout method;
measuring initial three-dimensional coordinates of each image control point using measuring instruments; and
correcting the initial three-dimensional coordinates of each image control point based on a GPS RTK multi-point correction method to obtain the three-dimensional coordinate data of the image control points in the target area.

3. The drone-based mobile precision surveying method for terrestrial terrain according to claim 1, wherein said determining the regional terrain data of the target area based on the three-dimensional coordinate data of the image control points in the target area and the position information of the drone by using the real-time dynamic differential positioning technology specifically comprises:
dividing the target area into multiple grids based on the three-dimensional coordinate data of the image control points in the target area; and
determining the regional terrain data of the target area based on absolute positions of the drone at different times, relative positions of each grid to each image control point, and relative positions of the drone to each grid during aerial survey of the drone at different times by using the real-time dynamic differential positioning technology, wherein the absolute positions of the drone at different times, the relative positions of each grid to each image control point, and the relative positions of the drone to each grid during the aerial survey of the drone are obtained through data signal transmission via radio.

4. The drone-based mobile precision surveying method for terrestrial terrain according to claim 1, wherein said correcting the regional terrain data of the signal-deficient area based on the three-dimensional coordinate data of the image control points in the target area and the regional terrain data of the target area by using the real-time dynamic differential positioning technology, to obtain the corrected regional terrain data of the signal-deficient area specifically comprises:
determining relative positions of each grid in the signal-deficient area to image control points in the signal-covered area based on the three-dimensional coordinate data of the image control points in the target area, wherein the grids are obtained by dividing the target area;
obtaining absolute positions of the drone at different times in the signal-deficient area through coordinate transformation based on the relative positions of each grid in the signal-deficient area to the image control points in the signal-covered area; and
obtaining the corrected regional terrain data of the signal-deficient area based on the absolute positions of the drone at different times in the signal-deficient area, relative positions of each grid to each image control point, and relative positions of the drone to each grid by using a real-time differential positioning technology, wherein the relative positions of each grid to each image control point and the relative positions of the drone to each grid are obtained through data signal transmission via radio.

5. The drone-based mobile precision surveying method for terrestrial terrain according to claim 4, wherein said obtaining the absolute positions of the drone at different times in the signal-deficient area through coordinate transformation based on the relative positions of the grids in the signal-deficient area to the image control points in the signal-covered area specifically comprises:
determining the absolute positions of the drone at different times in the signal-deficient area according to the following formula:
$${B}_{opp 3} = {B}_{opp 1} + {B}_{no} - {B}_{signal}$$
wherein Bₒₚₚ₃ is the absolute positions of the drone in the signal-deficient area at different times, Bₒₚₚ₁ is the relative positions of each grid to each image control point, Bₙₒ is three-dimensional coordinates of image control points in the signal-deficient area, and B_{signal} is the three-dimensional coordinates of the image control points in the signal-covered area.

6. The drone-based mobile precision surveying method for terrestrial terrain according to claim 4, wherein said obtaining the absolute positions of the drone at different times in the signal-deficient area through coordinate transformation based on the relative positions of the grids in the signal-deficient area to the image control points in the signal-covered area specifically comprises:
obtaining the absolute positions of the drone at different times in the signal-deficient area according to the following formula: B_{abs}=Bₒₚₚ₂+Bₒₚₚ₃;
wherein B_{abs}′ is the absolute positions of the drone in the signal-deficient area at different times, Bₒₚₚ₂ is the relative positions of the drone to each grid, and Bₒₚₚ₃ is the relative positions of the grids in the signal-deficient area to the image control points in the signal-covered area.

7. The drone-based mobile precision surveying method for terrestrial terrain according to claim 4, wherein said obtaining the corrected regional terrain data of the signal-deficient area based on the absolute positions of the drone at different times in the signal-deficient area, the relative positions of each grid to each image control point, and the relative positions of the drone to each grid by using the real-time differential positioning technology specifically comprises:
obtaining the corrected regional terrain data of the signal-deficient area according to the following formula: B_{bef2}′=DIFF(B_{abs}′, Bₒₚₚ₁, Bₒₚₚ₂);
wherein B_{ber2}′ is the corrected regional terrain data of the signal-deficient area; B_{abs}′ is the absolute positions of the drone in the signal-deficient area at different times, Bₒₚₚ₁ is the relative positions of each grid to each image control point, Bₒₚₚ₂ is the relative positions of the drone to each grid, and DIFF( ) is a real-time differential function.

8. A computer device, comprising: a memory, a processor and a computer program stored in the memory and executable on the processor, wherein the processor executes the computer program to implement steps of the drone-based mobile precision surveying method for terrestrial terrain according to claim 1.

9. A non-transitory computer-readable storage medium, wherein the computer-readable storage medium stores a computer program, and the computer program is executed by a processor to implement steps of the drone-based mobile precision surveying method for terrestrial terrain according to claim 1.

10. The computer device according to claim 8, wherein before said acquiring the three-dimensional coordinate data of the image control points in the target area and the position information of the drone, wherein the target area comprises the signal-covered area and the signal-deficient area, the method further comprises:
deploying the image control points in the target area by using a uniform layout method;
measuring initial three-dimensional coordinates of each image control point using measuring instruments; and
correcting the initial three-dimensional coordinates of each image control point based on a GPS RTK multi-point correction method to obtain the three-dimensional coordinate data of the image control points in the target area.

11. The computer device according to claim 8, wherein said determining the regional terrain data of the target area based on the three-dimensional coordinate data of the image control points in the target area and the position information of the drone by using the real-time dynamic differential positioning technology specifically comprises:
dividing the target area into multiple grids based on the three-dimensional coordinate data of the image control points in the target area; and
determining the regional terrain data of the target area based on absolute positions of the drone at different times, relative positions of each grid to each image control point, and relative positions of the drone to each grid during aerial survey of the drone at different times by using the real-time dynamic differential positioning technology, wherein the absolute positions of the drone at different times, the relative positions of each grid to each image control point, and the relative positions of the drone to each grid during the aerial survey of the drone are obtained through data signal transmission via radio.

12. The computer device according to claim 8, wherein said correcting the regional terrain data of the signal-deficient area based on the three-dimensional coordinate data of the image control points in the target area and the regional terrain data of the target area by using the real-time dynamic differential positioning technology, to obtain the corrected regional terrain data of the signal-deficient area specifically comprises:
determining relative positions of each grid in the signal-deficient area to image control points in the signal-covered area based on the three-dimensional coordinate data of the image control points in the target area, wherein the grids are obtained by dividing the target area;
obtaining absolute positions of the drone at different times in the signal-deficient area through coordinate transformation based on the relative positions of each grid in the signal-deficient area to the image control points in the signal-covered area; and
obtaining the corrected regional terrain data of the signal-deficient area based on the absolute positions of the drone at different times in the signal-deficient area, relative positions of each grid to each image control point, and relative positions of the drone to each grid by using a real-time differential positioning technology, wherein the relative positions of each grid to each image control point and the relative positions of the drone to each grid are obtained through data signal transmission via radio.

13. The computer device according to claim 12, wherein said obtaining the absolute positions of the drone at different times in the signal-deficient area through coordinate transformation based on the relative positions of the grids in the signal-deficient area to the image control points in the signal-covered area specifically comprises:
determining the absolute positions of the drone at different times in the signal-deficient area according to the following formula:
$${B}_{opp 3} = {B}_{opp 1} + {B}_{no} - {B}_{signal}$$
wherein Bₒₚₚ₃ is the absolute positions of the drone in the signal-deficient area at different times, Bₒₚₚ₁ is the relative positions of each grid to each image control point, Bₙₒ is three-dimensional coordinates of image control points in the signal-deficient area, and B_{signal} is the three-dimensional coordinates of the image control points in the signal-covered area.

14. The computer device according to claim 12, wherein said obtaining the absolute positions of the drone at different times in the signal-deficient area through coordinate transformation based on the relative positions of the grids in the signal-deficient area to the image control points in the signal-covered area specifically comprises:
obtaining the absolute positions of the drone at different times in the signal-deficient area according to the following formula: B_{abs}=Bₒₚₚ₂+Bₒₚₚ₃;
wherein B_{abs}′ is the absolute positions of the drone in the signal-deficient area at different times, Bₒₚₚ₂ is the relative positions of the drone to each grid, and Bₒₚₚ₃ is the relative positions of the grids in the signal-deficient area to the image control points in the signal-covered area.

15. The computer device according to claim 12, wherein said obtaining the corrected regional terrain data of the signal-deficient area based on the absolute positions of the drone at different times in the signal-deficient area, the relative positions of each grid to each image control point, and the relative positions of the drone to each grid by using the real-time differential positioning technology specifically comprises:
obtaining the corrected regional terrain data of the signal-deficient area according to the following formula: B_{bef2}′=DIFF(B_{abs}′, Bₒₚₚ₁, Bₒₚₚ₂);
wherein B_{ber2}′ is the corrected regional terrain data of the signal-deficient area; B_{abs}′ is the absolute positions of the drone in the signal-deficient area at different times, Bₒₚₚ₁ is the relative positions of each grid to each image control point, Bₒₚₚ₂ is the relative positions of the drone to each grid, and DIFF( ) is a real-time differential function.

16. The non-transitory computer-readable storage medium according to claim 9, wherein before said acquiring the three-dimensional coordinate data of the image control points in the target area and the position information of the drone, wherein the target area comprises the signal-covered area and the signal-deficient area, the method further comprises:
deploying the image control points in the target area by using a uniform layout method;
measuring initial three-dimensional coordinates of each image control point using measuring instruments; and
correcting the initial three-dimensional coordinates of each image control point based on a GPS RTK multi-point correction method to obtain the three-dimensional coordinate data of the image control points in the target area.

17. The non-transitory computer-readable storage medium according to claim 9, wherein said determining the regional terrain data of the target area based on the three-dimensional coordinate data of the image control points in the target area and the position information of the drone by using the real-time dynamic differential positioning technology specifically comprises:
dividing the target area into multiple grids based on the three-dimensional coordinate data of the image control points in the target area; and
determining the regional terrain data of the target area based on absolute positions of the drone at different times, relative positions of each grid to each image control point, and relative positions of the drone to each grid during aerial survey of the drone at different times by using the real-time dynamic differential positioning technology, wherein the absolute positions of the drone at different times, the relative positions of each grid to each image control point, and the relative positions of the drone to each grid during the aerial survey of the drone are obtained through data signal transmission via radio.

18. The non-transitory computer-readable storage medium according to claim 9, wherein said correcting the regional terrain data of the signal-deficient area based on the three-dimensional coordinate data of the image control points in the target area and the regional terrain data of the target area by using the real-time dynamic differential positioning technology, to obtain the corrected regional terrain data of the signal-deficient area specifically comprises:
determining relative positions of each grid in the signal-deficient area to image control points in the signal-covered area based on the three-dimensional coordinate data of the image control points in the target area, wherein the grids are obtained by dividing the target area;
obtaining absolute positions of the drone at different times in the signal-deficient area through coordinate transformation based on the relative positions of each grid in the signal-deficient area to the image control points in the signal-covered area; and
obtaining the corrected regional terrain data of the signal-deficient area based on the absolute positions of the drone at different times in the signal-deficient area, relative positions of each grid to each image control point, and relative positions of the drone to each grid by using a real-time differential positioning technology, wherein the relative positions of each grid to each image control point and the relative positions of the drone to each grid are obtained through data signal transmission via radio.

19. The non-transitory computer-readable storage medium according to claim 18, wherein said obtaining the absolute positions of the drone at different times in the signal-deficient area through coordinate transformation based on the relative positions of the grids in the signal-deficient area to the image control points in the signal-covered area specifically comprises:
determining the absolute positions of the drone at different times in the signal-deficient area according to the following formula:
$${B}_{opp 3} = {B}_{opp 1} + {B}_{no} - {B}_{signal}$$
wherein Bₒₚₚ₃ is the absolute positions of the drone in the signal-deficient area at different times, Bₒₚₚ₁ is the relative positions of each grid to each image control point, Bₙₒ is three-dimensional coordinates of image control points in the signal-deficient area, and B_{signal} is the three-dimensional coordinates of the image control points in the signal-covered area.

20. The non-transitory computer-readable storage medium according to claim 18, wherein said obtaining the absolute positions of the drone at different times in the signal-deficient area through coordinate transformation based on the relative positions of the grids in the signal-deficient area to the image control points in the signal-covered area specifically comprises:
obtaining the absolute positions of the drone at different times in the signal-deficient area according to the following formula: B_{abs}=Bₒₚₚ₂+Bₒₚₚ₃;
wherein B_{abs}′ is the absolute positions of the drone in the signal-deficient area at different times, Bₒₚₚ₂ is the relative positions of the drone to each grid, and Bₒₚₚ₃ is the relative positions of the grids in the signal-deficient area to the image control points in the signal-covered area.
